(19) United States
(12) Patent Application Publication
(10) Pub. No.: US 2016/0210933 A1
(43) Pub. Date: Jul. 21, 2016

(54) SMART HELMET

(71) Applicant: KDH-DESIGN SERVICE INC., Taipei City (TW)

(72) Inventor: Younger Liang, Taipei City (TW)

(21) Appl. No.: 14/961,796

(22) Filed: Dec. 7, 2015

(30) Foreign Application Priority Data
Jan. 16, 2015 (TW) 104200714

(51) Int. Cl. G09G 5/00; G06T 19/00; G06T 1/20; G01C 21/36; G02B 27/01

(52) U.S. Cl. CPC G09G 5/006; G01C 21/3667; G02B 27/0176; G06T 1/20; G06T 19/006; G09G 2380/10; G09G 2370/022; G09G 2360/08; G09G 2320/10

(57) ABSTRACT

A smart helmet wirelessly connected to a server includes a main body, a central processing device, a sensing device, a communication transmitting/receiving device, an image projecting device, and a power supply. With these arrangements, the smart helmet can transmit different signals sensed by the sensing device to the central processing device. After being processed, the processed signals are uploaded to a cloud server via the communication transmitting/receiving device, and the cloud server sends data processed from the signals back to the central processing device via the communication transmitting/receiving device, then the data is turned to an image data to project. Or the smart helmet is capable of remotely monitoring a user's driving information and safety.

This application claims the priority benefit of Taiwan patent application number 104200714 filed on Jan. 16, 2015.

### FIELD OF THE INVENTION

The present invention relates to a smart helmet, and more specifically, to a smart helmet that is capable of providing various driving data and remotely monitoring a user's safety while driving a motorcycle.

### BACKGROUND OF THE INVENTION

According to the current law, the motorcycle driver must wear a protective helmet when driving. Most various helmets offer protection above the neck, and some helmets are provided with external event data recorders (EDRs) or wireless communication devices by the drivers. As a result, general helmets have no additional functions.

Also, some motorcycle drivers will add navigation devices or EDRs to their motorcycles. However, it is apt to distract the drivers from driving when looking at this kind of devices to easily cause danger or a crash. In addition, apart from the compatibility and the integration problems, it is heavy to couple the screen of the navigation devices or EDRs to the helmets to burden the drivers' neck with the additional weight.

It is therefore tried by the inventor to develop an improved smart helmet, which can be provided with the helmet and offer various information on a suitable place without the risk of distraction, to overcome the problems of the conventional smart helmets.

### SUMMARY OF THE INVENTION

To solve the above problems, a primary object of the present invention is to provide a smart helmet that can smartly sense various signals to wirelessly interact with a cloud server to interchange information with the cloud server.

Another object of the present invention is to provide a smart helmet that can remotely monitor a user's safety while driving a motorcycle.

To achieve the above and other objects, the smart helmet wirelessly connected to a server according to the present invention includes a main body, a central processing device, a sensing device, an image projecting device, a communication transmitting/receiving device, and a power supply.

The main body internally defines at least one receiving space and has a wearing and an observation portion. The observation portion is located corresponding to at least one visor. The central processing device has a central processing unit (CPU) and an image processor, which is electrically connected to the CPU. The sensing device has a plurality of sensors, which are provided within the main body and electrically connected to the central processing device, and senses and transmits the sensed signal to the central processing device to process. The image projecting device is located in the main body and electrically connected to the central processing device, and projects the image data onto the visor. The communication transmitting/receiving device electrically connected to the central processing device wirelessly transmits the signals processed by the central processing device to the server and then wirelessly receives the data sent back from the server. The power supply is electrically connected to the central processing device, the sensing device, image projecting device, and the communication transmitting/receiving device and produces power.

With the connection with the server, the sensing device provided within the smart helmet can sense different signals and transmits the sensed signals to the server, and then the server sends instant data related to the user's location back to the smart helmet for user instant reference.

Furthermore, with the server receives the sensed signals, such as location data, or the information of when the motorcycle speeds up, the smart helmet can remotely monitor a user's location and safety while driving a motorcycle.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a smart helmet according to a first preferred embodiment of the present invention;

FIG. 2 is an assembled sectional view of FIG. 1;

FIG. 3 is a block diagram of the smart helmet according to the first preferred embodiment of the present invention; and

FIGS. 4 to 9 are block diagrams showing the working manner of the smart helmet according to the first preferred embodiment of the present invention;

FIG. 10 is a sectional view of the smart helmet according to a second preferred embodiment of the present invention; and

FIGS. 11 to 13 are block diagrams showing the working manner of the smart helmet according to the first preferred embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

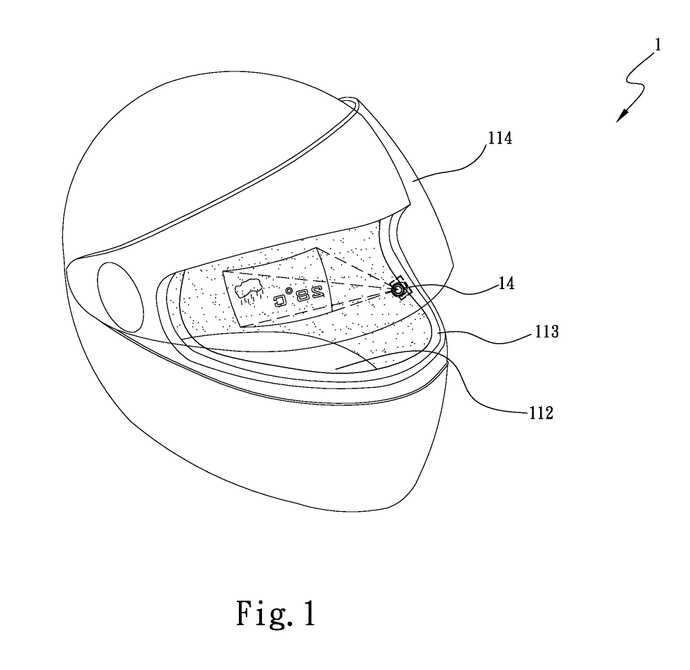

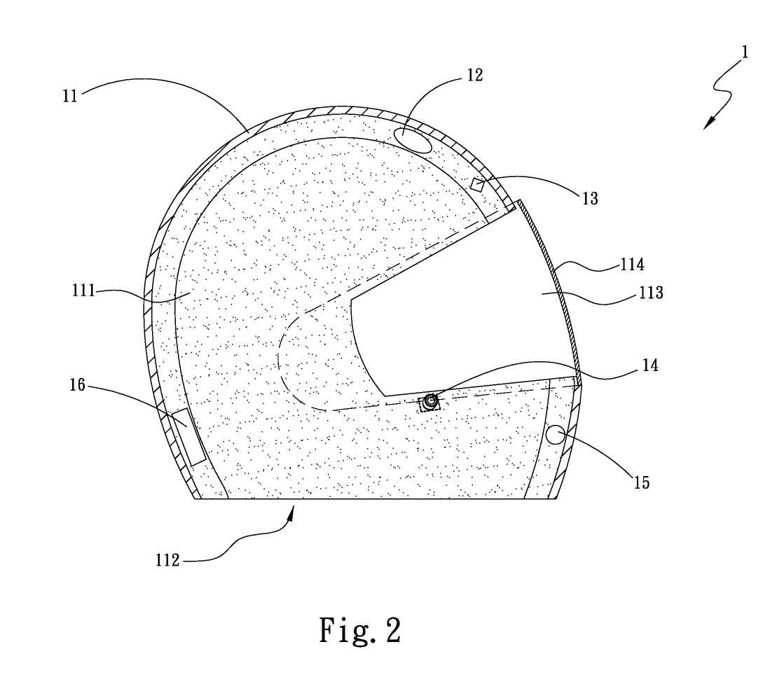

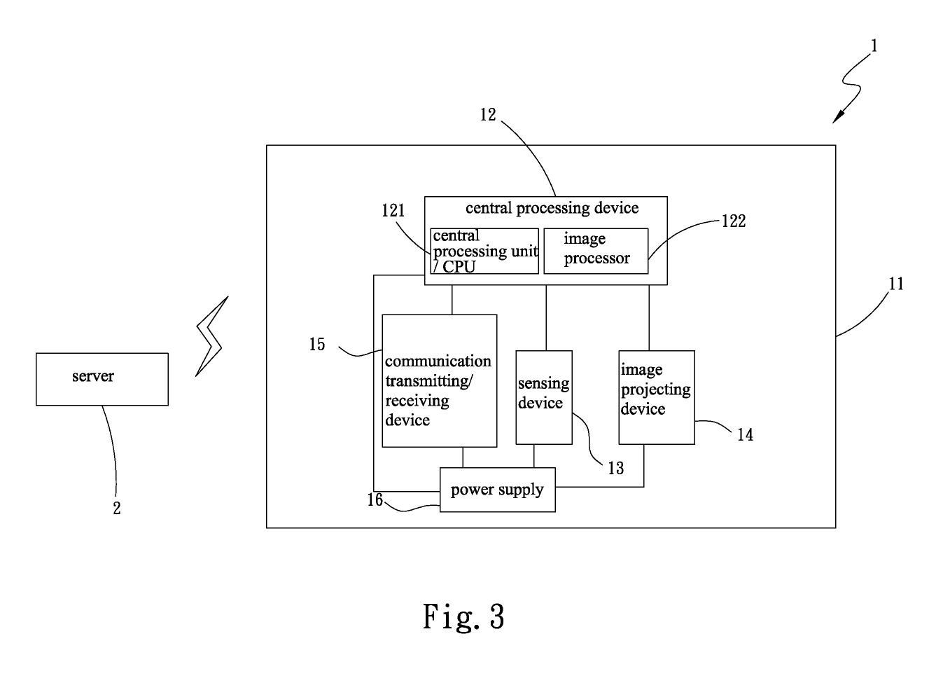

Please refer to FIGS. 1 to 3, which are assembled perspective view, assembled sectional view, and block diagram, respectively, of a smart helmet according to a first preferred embodiment of the present invention. As shown, the smart helmet 1 wirelessly connected to a server 2 includes a main body 11, a central processing device 12, a sensing device 13, an image projecting device 14, a communication transmitting/receiving device 15, and a power supply 16.

The main body 11 internally defines at least one receiving space 111 and has a wearing and an observation portion 112, 113. The observation portion 113 is located corresponding to at least one visor 114. A user's head is received in the receiving space 111 through the wearing portion 112, and the user's eyes corresponding to the observation portion 113.

The central processing device 12 has a central processing unit (CPU) 121 and an image processor 122, which is electrically connected to the CPU 121. The CPU 121 is used for processing the signals sensed by the sensing device 13, and outputs data processed by the image processor 122 for the user reference.

The sensing device 13 has a plurality of sensors, which are provided within the main body 11 and electrically connected to the central processing device 12, and senses and transmits the sensed signals to the central processing device 12 to process. The sensing device 13 further has a height sensing sensor 131, a triaxial acceleration sensor 132, a temperature and humidity sensor 133, a GPS locator 134, and a direction sensor 135, all of which can smartly sense different signals and send them to the central processing device 12 to process.

The image projecting device 14 is located in the main body 11 and electrically connected to the central processing device 12, and projects the image data processed by the central processing device 12 onto the visor 114. The image projecting device 14 is a micro-projector. After the sensed signals is processed by the CPU 121 and transmitted to the image processor 122, the signals are turned into image data, which are transmitted to the image projecting device 14 and projected onto a adjustable location according to user's favor.

The communication transmitting/receiving device 15 electrically connected to the central processing device 12 wirelessly transmits the signals processed by the central processing device 12 to the server and then wirelessly receives the data sent back from the server in a manner of 3G, 4G, LTE, Z-WAVE, ZIGBEE, WIFI, Bluetooth, or infrared.

The power supply 16 is electrically connected to the central processing device 12, the sensing device 13, image projecting device 14, and the communication transmitting/receiving device 15, and produces power.

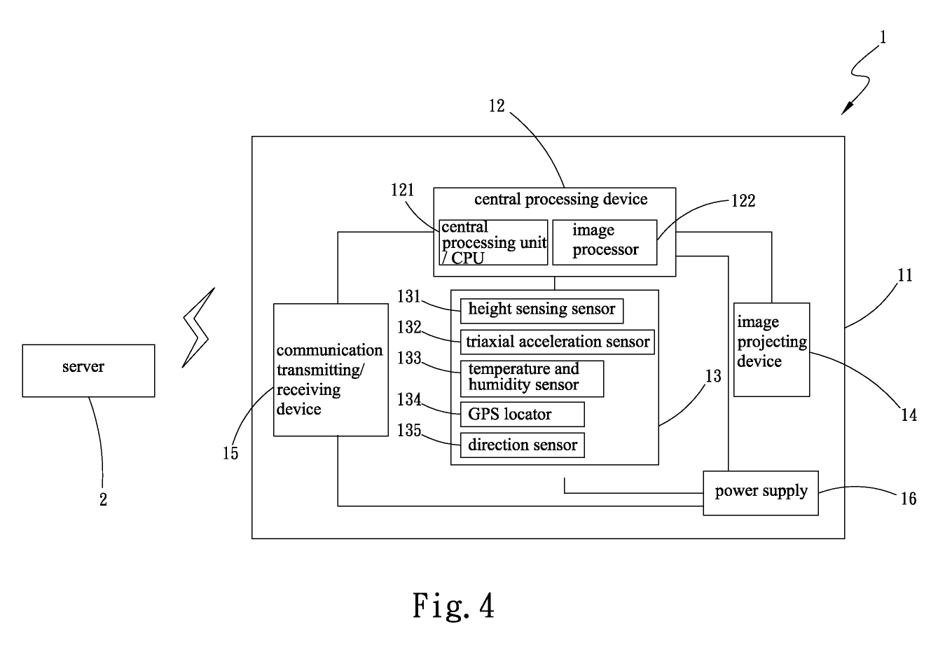

Please refer to FIGS. 4 to 9, which are block diagrams showing the working manner of the smart helmet 1 of the present invention. As shown, the smart helmet 1 includes a main body 11, a central processing device 12, a sensing device 13, an image projecting device 14, a communication transmitting/receiving device 15, and a power supply 16. The sensing device 13 further has a height sensing sensor 131, a triaxial acceleration sensor 132, a temperature and humidity sensor 133, a GPS locator 134, and a direction sensor 135, all of which can smartly sense different signals and send them via the communication transmitting/receiving device 15 to the server 2. Thereafter, the signals is processed into various data to send back to the central processing device 12 of the smart helmet 1 to process into image data to project onto the visor 114 via the image projecting device 14 for the user reference.

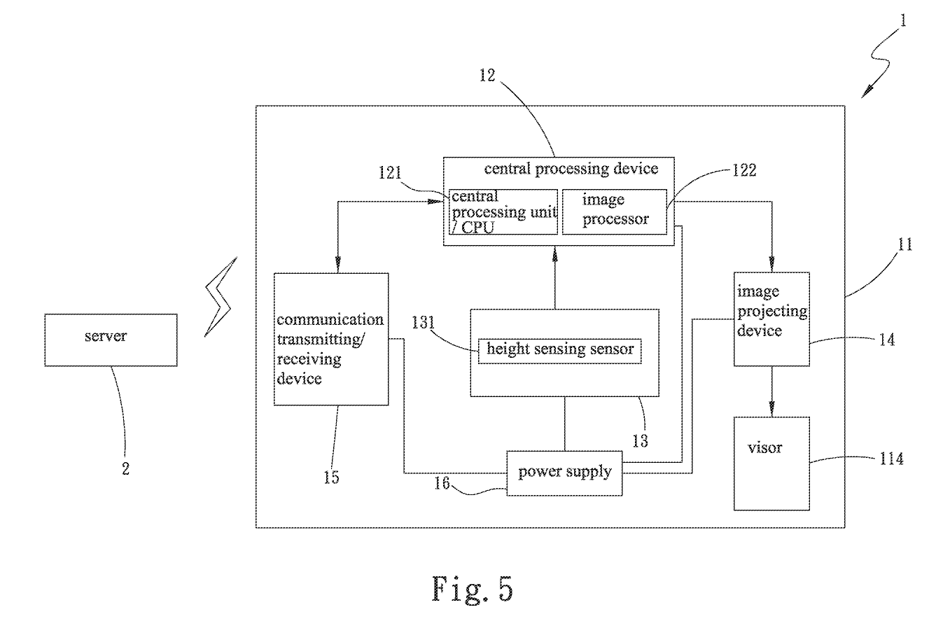

As shown in FIG. 5, the height sensor 131 instantly generates a signal after sensing the height information according to the user's current location, and transmits the sensed signal to the central processing device 12 to process, then to the server 2 via the communication transmitting/receiving device 15. Thereafter, the server 2 sends the height or the surrounding terrain data back to the central processing device 12 of the smart helmet 1 after finding out the data corresponding to the sensed signals in its database, and then the image data processed from the central processing device 12 is projected onto the visor 114 by the image projecting device 14.

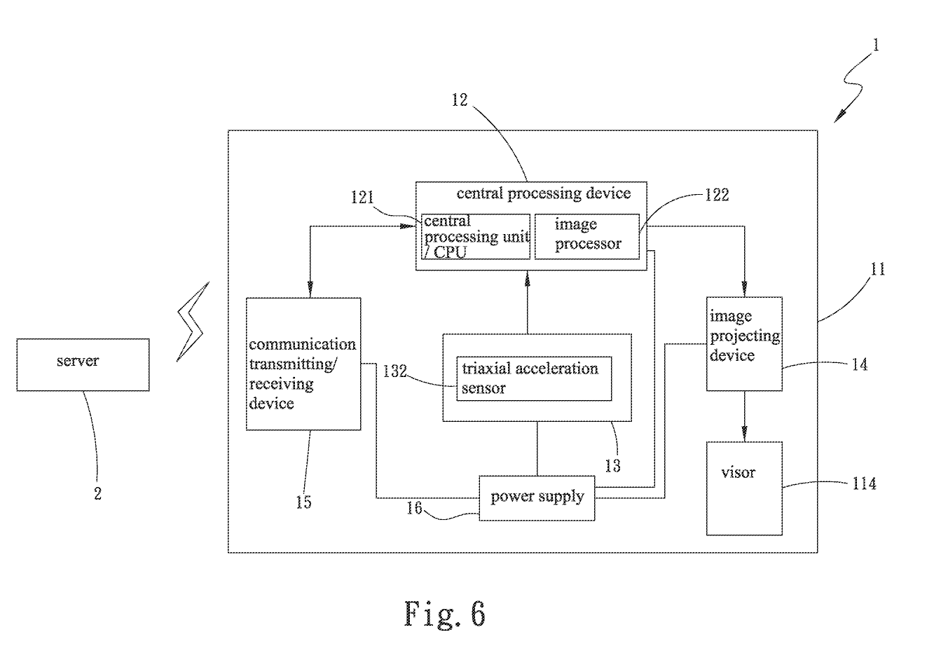

As shown in FIG. 6, the triaxial acceleration sensor 132 instantly generates an instant displacement signal, which is an instant acceleration signal, an average speed signal, or a maximum acceleration signal, after sensing the various speed information according to the user's current driving information, and transmits the sensed signals to the central processing device 12 to process, then to the server 2 via the communication transmitting/receiving device 15. Thereafter, apart from detecting and keeping monitoring the instant displacement signal, the server 2 is capable of immediately notifying the relevant rescue units and related personnel to rescue the user when an unusual instant acceleration, average speed occurs, or the average speed stays too low for a while.

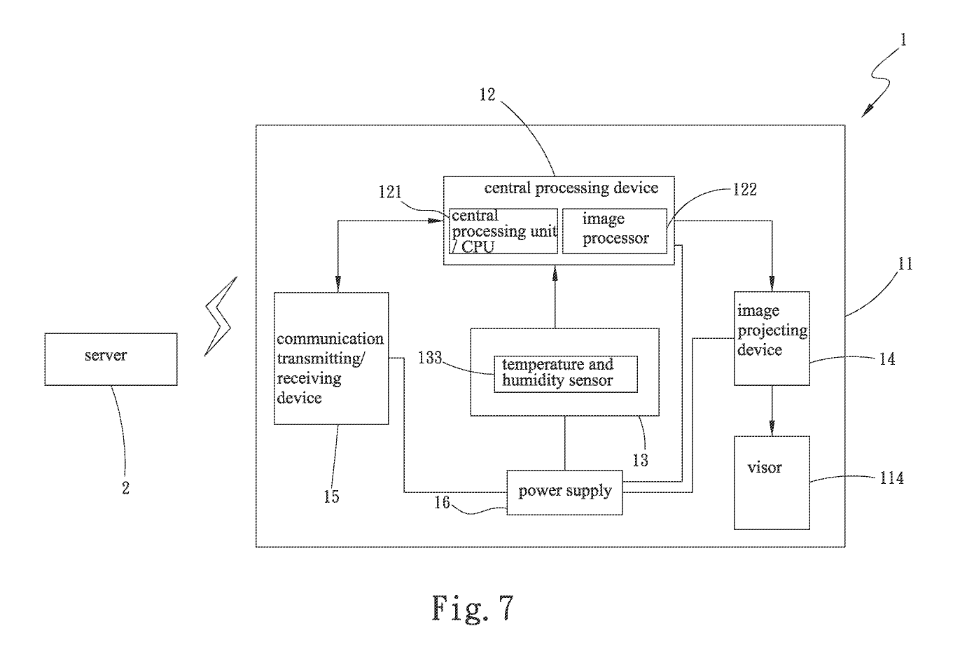

As shown in FIG. 7, the temperature and humidity sensor 133 generates a current temperature and humidity signal according to the user's current driving information, and transmits the sensed signals to the central processing device 12 to process, then to the server 2 via the communication transmitting/receiving device 15. Thereafter, the server 2 sends the current temperature and humidity data back to the central processing device 12 of the smart helmet 1 after finding out the data corresponding to the sensed signals in its database, and then the image data processed from the central processing device 12 is projected onto the visor 114 by the image projecting device 14 for the user reference, such that the user can put on a coat or a raincoat in advance when the local temperature is cold from a distance, for example of a kilometer away or bad weather according the data shown on the visor 114.

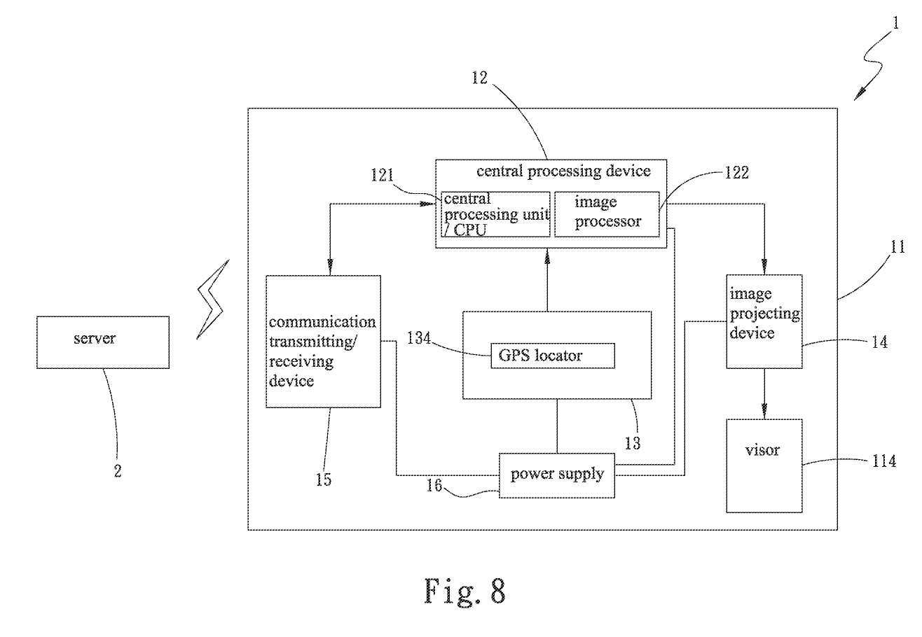

As shown in FIG. 8, the GPS locator 134 generates a locating signal according to the user's current driving information, and transmits the sensed signals to the central processing device 12 to process, then to the server 2 via the communication transmitting/receiving device 15. Thereafter, apart from detecting and keeping monitoring the locating signal, along with the triaxial acceleration sensor 132, the server 2 is capable of obtaining the corresponding data related to the user's current driving informationand sends the locating data back to the central processing device 12 of the smart helmet 1. Then, the image data, showing the user's current driving path or a relative map, processed from the central processing device 12 is projected onto the visor 114 by the image projecting device 14 for the user reference, such that the user can plan a preferable path in advance.

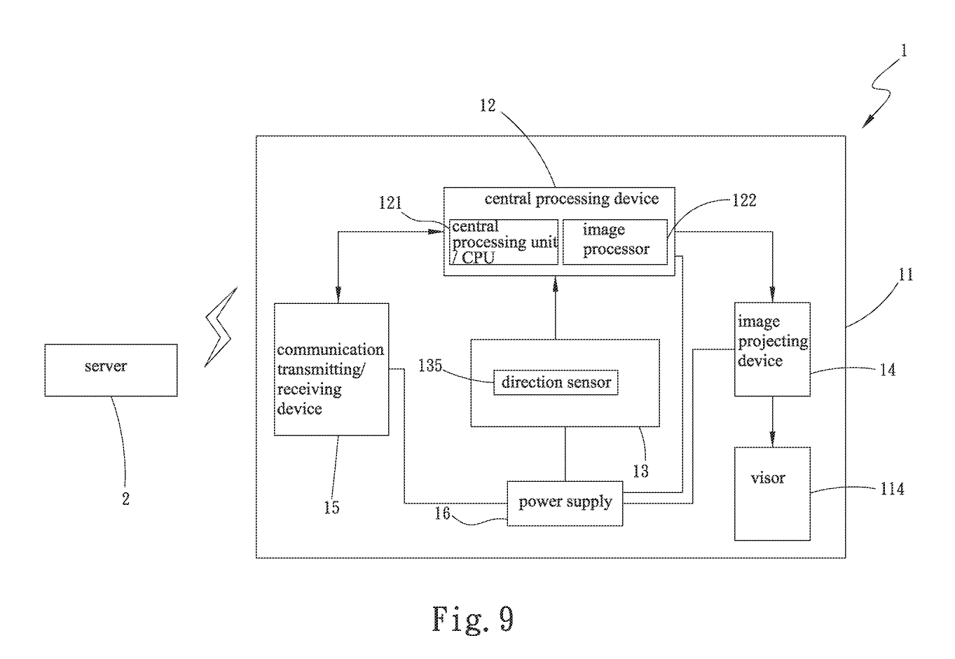

As shown in FIG. 9, the direction sensor 135 generates a direction changing signal according to the user's current driving information, and transmits the sensed signals to the central processing device 12 to process, then to the server 2 via the communication transmitting/receiving device 15. Thereafter, apart from detecting and keeping monitoring the direction changing signal, along with the triaxial acceleration sensor 132 and the GPS locator 134, the server 2 is capable of obtaining the corresponding data related to the user's current driving information and immediately notifying the relevant rescue units and related personnel to rescue the user when the user does not keep on the planned path, an unusual locating signal detected by the GPS locator 134, or an unusual high speed signal or too much deviation detected by the triaxial acceleration sensor 132, or an unusual driving signal detected by the direction sensor 15.

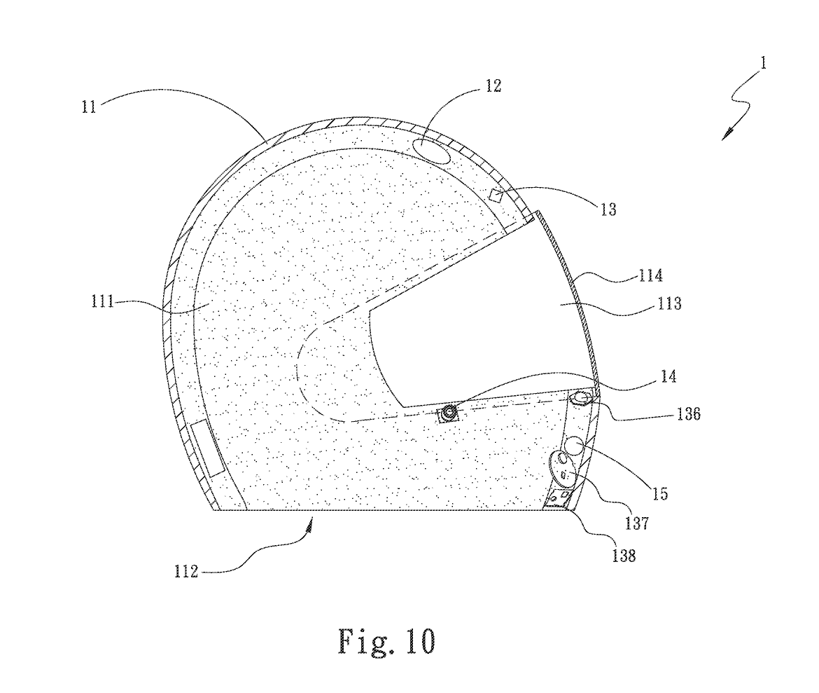

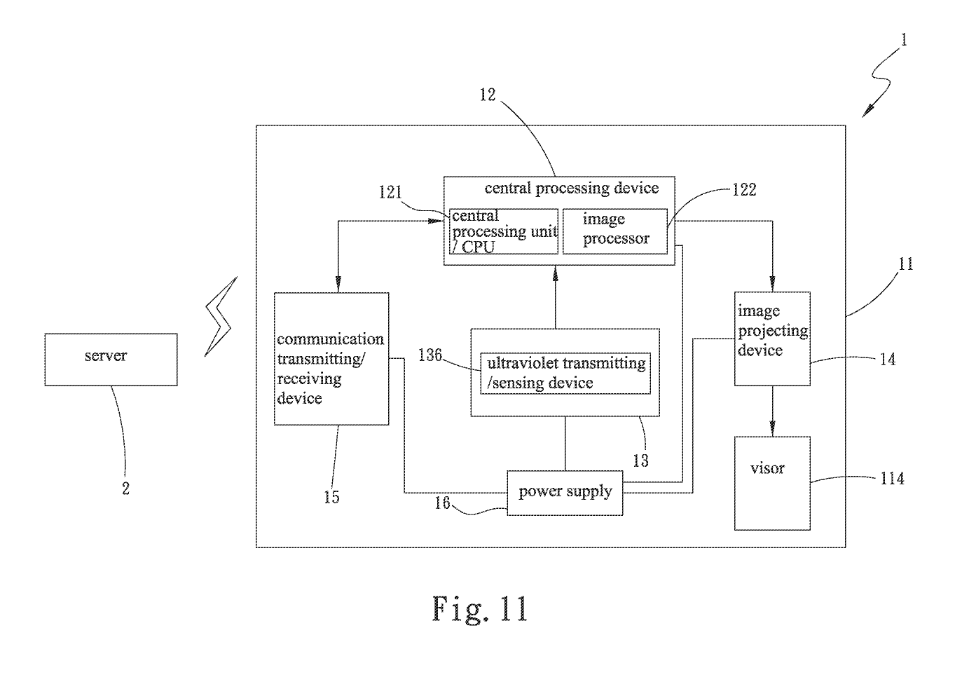

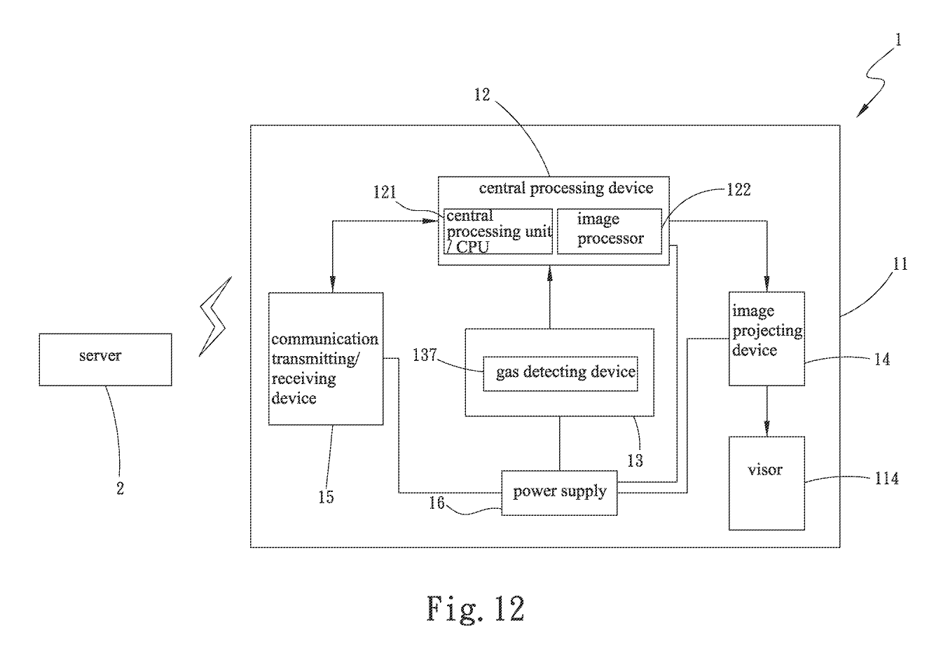

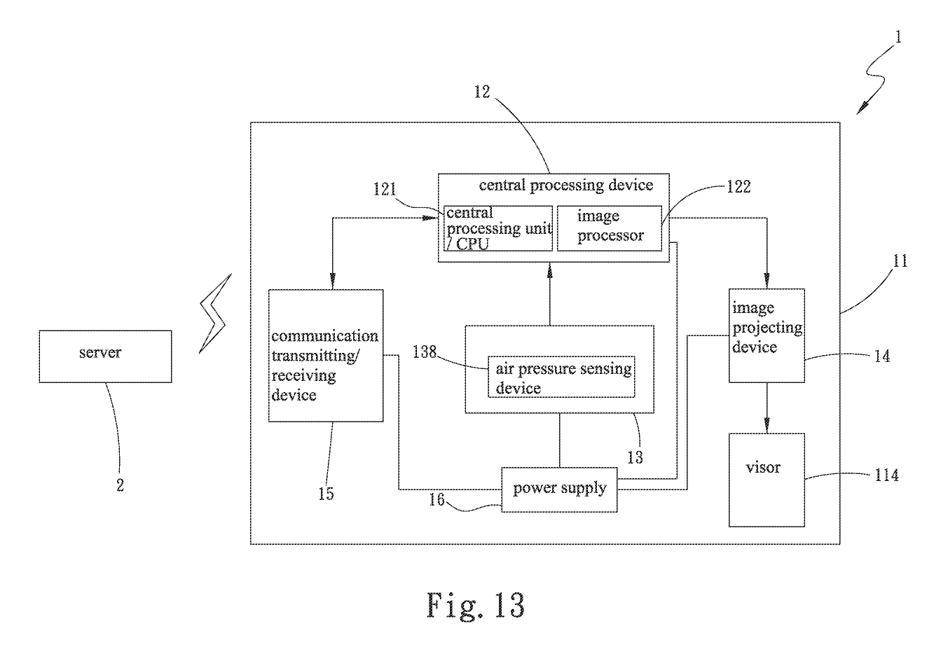

Please refer to FIG. 10, which is a sectional view of the smart helmet according to a second preferred embodiment of the present invention, and FIGS. 11 to 13, which are block diagrams showing the working manner of the smart helmet according to the first preferred embodiment of the present invention. The second embodiment of the smart helmet 1 is generally structurally similar to the first embodiment except that, in this second embodiment, the smart helmet 1 further includes an ultraviolet transmitting/sensing device 136, a gas detecting device 137, and an air pressure sensing device 138.

The ultraviolet transmitting/sensing device 136 for transmitting the sensed signal to the central processing device 12 to process is disposed within the main body 11 and located adjacent to the observation portion 113 and electrically connected to the central processing device 12.

The gas detecting device 137 for transmitting the sensed signal to the central processing device 12 to process is disposed within the main body 11 and located adjacent to the observation portion 113 and electrically connected to the central processing device 12.

The air pressure sensing device 138 for transmitting the sensed signal to the central processing device 12 to process is disposed within the main body 11 and located adjacent to the wearing portion 112 or the observation portion 113 and electrically connected to the central processing device 12.

The ultraviolet transmitting/sensing device 136 senses strength of the ambient light around the user and generates a signal, then the sensed signal is transmitted to the central processing device 12 to process to obtain ultraviolet strength data, which is projected onto the visor 114 by the image processor 122 for user's instantaneous reference after being processed by the image processor 122. Alternatively, the ultraviolet strength data can be sent to others after being transmitted to the server 2 via the communication transmitting/receiving device 15.

The gas detecting device 137 senses quality of the ambient air around the user and generates a signal, then the sensed signal is transmitted to the central processing device 12 to process to obtain air quality data, which is projected onto the visor 114 by the image processor 122 for user's instantaneous reference after being processed by the image processor 122. Alternatively, the air quality data can be sent to others after being transmitted to the server 2 via the communication transmitting/receiving device 15.

The air pressure sensing device 138 senses air-pressure of the ambient air around the user and generates a signal, then the sensed signal is transmitted to the central processing device 12 to process to obtain a height data, which is projected onto the visor 114 by the image processor 122 for user's instantaneous reference after being processed by the image processor 122. Alternatively, the height data can be sent to others after being transmitted to the server 2 via the communication transmitting/receiving device 15.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A smart helmet wirelessly connected to a server, comprising:
a main body internally defining at least one receiving space and having a wearing and an observation portion;
a central processing device having a central processing unit (CPU) and an image processor, which is electrically connected to the CPU;
a sensing device has a plurality of sensors, which are provided within the main body and electrically connected to the central processing device, and sensing and transmitting the sensed signals to the central processing device to process;
an image projecting device being located in the main body and electrically connected to the central processing device and projecting the image data onto the visor;
a communication transmitting/receiving device electrically connected to the central processing device wirelessly transmitting the signals processed by the central processing device to the server and then wirelessly receiving the data sent back from the server; and
a power supply being electrically connected to the central processing device, the sensing device, image projecting device, and the communication transmitting/receiving device and producing power.

2. The smart helmet as claimed in claim 1, wherein the sensing device further has a height sensing sensor, a triaxial acceleration sensor, a temperature and humidity sensor, a GPS locator, and a direction sensor, all of which can smartly sense different signals and send them to the central processing device to process.

3. The smart helmet as claimed in claim 2, wherein the height sensor generates a signal after sensing the height information according to the user's current location, and transmits the sensed signal to the central processing device to process, then to the server via the communication transmitting/receiving device; and thereafter, the server sends the geographical data corresponding to the sensed signals back to the central processing device of the smart helmet, and then the image data processed from the central processing device is projected onto the visor by the image projecting device.

4. The smart helmet as claimed in claim 2, wherein the triaxial acceleration sensor instantly generates an instant displacement signal after sensing the various speed information according to the user's current driving information, and transmits the sensed information to the central processing device to process, then to the server via the communication transmitting/receiving device; and thereafter, apart from detecting and keeping monitoring the instant displacement signal, the server simultaneously sends displacement data back to the central processing device of the smart helmet after processing, and then the image data processed from the central processing device is projected onto the visor by the image projecting device.

5. The smart helmet as claimed in claim 2, wherein the temperature and humidity sensor generates a current temperature and humidity signal according to the user's current driving information, and transmits the sensed signals to the central processing device to process, then to the server via the communication transmitting/receiving device; and thereafter, the server sends the current temperature and humidity data back to the central processing device of the smart helmet after finding out the data corresponding to the sensed signals in its database, and then the image data processed from the central processing device is projected onto the visor by the image projecting device for the user reference, such that the user can put on a coat or a raincoat in advance when the local temperature is cold from a distance, for example of a kilometer away or bad weather according the data shown on the visor.

6. The smart helmet as claimed in claim 2, wherein the GPS locator generates a locating signal according to the user's current driving information, and transmits the sensed signals to the central processing device to process, then to the server via the communication transmitting/receiving device; thereafter, apart from detecting and keeping monitoring the locating signal, the server is capable of obtaining the corresponding data related to the user's current driving information and sends the locating data back to the central processing device of the smart helmet; and then, the image data, showing the user's current driving path or a relative map, processed from the central processing device is projected onto the visor by the image projecting device for the user reference, such that the user can plan a preferable path in advance.

7. The smart helmet as claimed in claim 2, wherein the direction sensor generates a direction changing signal according to the user's current driving information, and transmits the sensed signals to the central processing device to process, then to the server via the communication transmitting/receiving device, and the server keeps detecting and monitoring the direction changing signal.

8. The smart helmet as claimed in claim 1, wherein the power supply is a battery or a solar power supply device.

9. The smart helmet as claimed in claim 1, wherein The communication transmitting/receiving device wirelessly transmits and receives the signals between the central processing device and the server in a manner selected from the group consisting of 3G, 4G, LTE, Z-WAVE, ZIGBEE, WIFI, Bluetooth, and infrared.

10. The smart helmet as claimed in claim 1, further comprising an ultraviolet transmitting/sensing device, which for transmitting the sensed signal to the central processing device to process being disposed within the main body and selectively located adjacent to the observation portion or the wearing portion and electrically connected to the central processing device.

11. The smart helmet as claimed in claim 1, further comprising a gas detecting device, which for transmitting the sensed signal to the central processing device to process being disposed within the main body and selectively located adjacent to the observation portion and electrically connected to the central processing device.

12. The smart helmet as claimed in claim 1, further comprising an air pressure sensing device, which for transmitting the sensed signal to the central processing device to process being disposed within the main body and selectively located adjacent to the observation portion or the wearing portion and electrically connected to the central processing device.
